(19) United States
(12) Patent Application Publication
(10) Pub. No.: US 2007/0221390 A1
(43) Pub. Date: Sep. 27, 2007

(54) Landscape Edging Apparatus For Front End Loader

(76) Inventors: Raymond C. Hager, Mankato, MN (US); Sydney A. Hager, Waseca, MN (US)

Correspondence Address: Moore & Hansen, PLLP, Suite 4850, 225 South Sixth Street, Minneapolis, MN, 55402, US

(21) Appl. No.: 11/676,840

(22) Filed: Feb. 20, 2007

Related U.S. Application Data
(60) Provisional application No. 60/774,887, filed on Feb. 17, 2006.

(51) Int. Cl. A01B 33/00

(52) U.S. Cl. 172/42

(57) ABSTRACT

A landscaping tool is mounted on a side of a motorized implement, such as a skid-steer loader or a walk-behind compact utility loader. The landscaping tool may be embodied, for example, as an edging tool or a sod cutting tool. The motorized implement is characterized by a pivot point, about which the motorized implement pivots as it turns. In some embodiments, the landscaping tool is located proximate the pivot point to enhance maneuverability.

### TECHNICAL BACKGROUND

The disclosure relates generally to earth working equipment. More particularly, the disclosure relates to equipment for digging trenches in earth.

### BACKGROUND

In the landscaping industry, it is often desirable to dig trenches in the earth. For example, landscapers dig trenches to define beds, install plastic or steel edging, and install irrigation systems. Conventionally, such trenches have been dug by hand using shovels. However, manual trench digging can be extremely labor intensive, consuming several worker-hours of labor.

To improve the efficiency of trench digging, many landscapers use trenching equipment. A variety of trenching equipment is available to accommodate the differing needs of landscapers. For example, mini-trenchers weighing a few hundred pounds can be used to dig trenches up to approximately a foot deep. For tasks requiring a deeper trench, larger trenchers weighing thousands of pounds can dig trenches that are several feet deep.

In addition to standalone trenching equipment, trenching attachments are available for use with other equipment. As a particular example, a number of manufacturers make trenching attachments that can be attached to skid-steer loaders using a universal skid-steer attachment bracket to attach the trenching attachment to the front of the skid-steer loader. In some such trenching attachments, a hydraulic motor runs off the hydraulic system of the skid-steer loader. The hydraulic motor turns a chain, which digs the trench. A spoil auger carries the dirt away from the trench. While such trenching attachments exhibit adequate performance for digging relatively straight trenches, one drawback is that they are often not sufficiently maneuverable to dig trenches that have more complicated patterns, including, for example, patterns incorporating sharp turns or corners.

### SUMMARY OF THE DISCLOSURE

According to various example embodiments, a landscaping tool is mounted on a side of a motorized implement, such as a skid-steer loader or a walk-behind compact utility loader. The landscaping tool may be embodied, for example, as an edging tool or a sod cutting tool. The motorized implement is characterized by a pivot point, about which the motorized implement pivots as it turns. In some embodiments, the landscaping tool is located proximate the pivot point.

One embodiment is directed to a landscaping apparatus for use with a motorized implement. The landscaping apparatus comprises a landscaping tool and a mounting assembly. The mounting assembly mounts the landscaping tool proximate a side portion of the motorized implement.

Another embodiment is directed to an apparatus for use with a motorized implement having an attachment bracket configured to provide an attachment point for any of a variety of tools. The apparatus comprises a meeting plate configured to be attached to the attachment bracket. An arm extends from the meeting plate and along a side portion of the motorized implement toward a back portion of the motorized implement. The arm has a terminus located proximate the side portion of the motorized implement. A tool is attached to the terminus of the arm.

Various embodiments may provide certain advantages. For instance, with the tool located proximate the pivot point of the motorized implement, the effective turn radius of the tool may be reduced, thereby enhancing maneuverability. As a result, a landscaping professional can dig trenches that have relatively complex patterns, including sharp turns and corners. Enhanced maneuverability can also be an advantage for tools other than edging tools, such as, for example, sod cutters and cable plows. The tool can be operated in conjunction with either a riding motorized implement, such as a skid-steer loader, or a walk-behind motorized implement, such as a compact utility loader.

Additional objects, advantages, and features will become apparent from the following description and the claims that follow, considered in conjunction with the accompanying drawings.

### BRIEF DESCRIPTION OF THE DRAWINGS

FIG. 1 illustrates a landscaping apparatus according to one embodiment.

FIG. 2 is a side view of the landscaping apparatus shown in FIG. 1.

FIG. 3 illustrates a portion of the landscaping apparatus in an operating configuration.

FIG. 4 illustrates the portion of the landscaping apparatus shown in FIG. 3 in a storage configuration.

FIG. 5 is a top view of a landscaping apparatus attached to a side of a skid-steer loader, according to another embodiment.

### DESCRIPTION OF VARIOUS EMBODIMENTS

According to various embodiments, a tool, such as a landscaping tool is mounted on a side of a motorized implement, such as a skid-steer loader or a walk-behind compact utility loader. The landscaping tool may be embodied, for example, as an edging tool or a sod cutting tool. The motorized implement is characterized by a pivot point, about which the motorized implement pivots as it turns. In some embodiments, the landscaping tool is located proximate the pivot point.

The following description of various embodiments implemented in a front end loader is to be construed by way of illustration rather than limitation. This description is not intended to limit the invention or its applications or uses. For example, while various embodiments are described as being implemented in a skid-steer loader, it will be appreciated that the principles of the disclosure are applicable to apparatuses operable in other environments, such as walk-behind compact utility loaders. In addition, while some embodiments are described as being implemented using an edging tool, it will be appreciated that the principles of the disclosure are also applicable to other tools, such as, for example, sod cutters and cable plows.

In the following description, numerous specific details are set forth in order to provide a thorough understanding of various embodiments. It will be apparent to one skilled in the art that some embodiments may be practiced without some or all of these specific details. In other instances, well known components and process steps have not been described in detail.

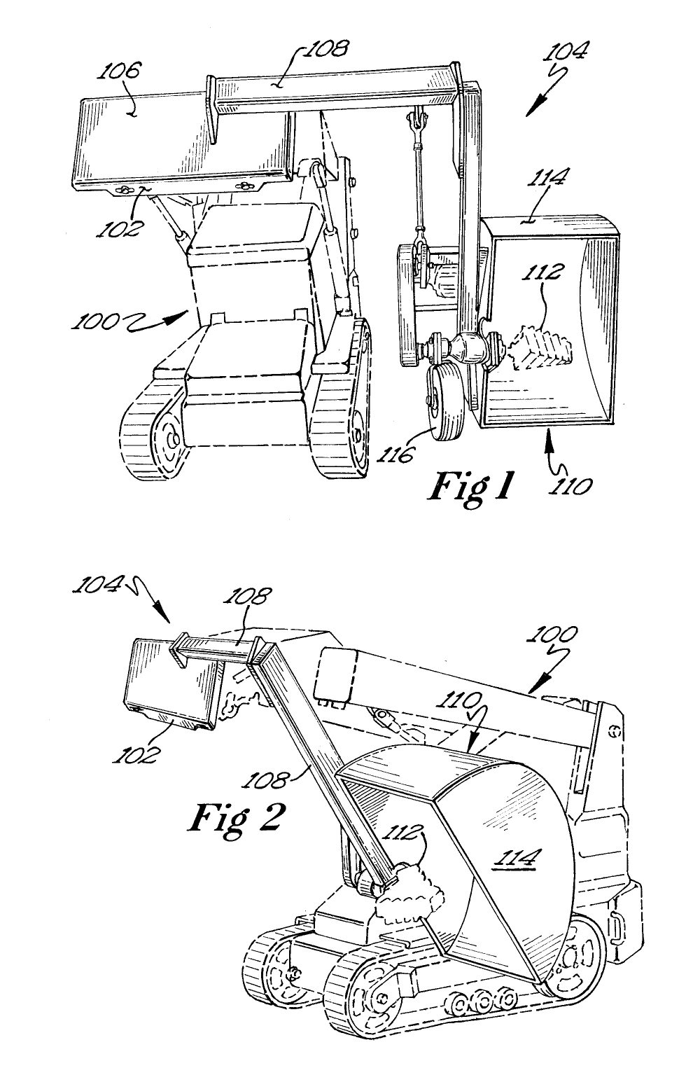

Referring now to the drawings, FIGS. 1 and 2 illustrate a landscaping apparatus according to one embodiment. A motorized implement, illustrated in FIGS. 1 and 2 as a compact utility loader 100, has one or more universal attachment brackets 102 that are designed to accommodate a variety of tools. For example, the DINGO series compact utility loaders commercially available from The Toro Company of Bloomington, Minn., can accommodate a variety of buckets, auger power heads, and other tools mounted on the front of the compact utility loader 100. Such compact utility loaders can operate on gasoline or diesel fuel, and may use wheels or tracks as a locomotive mechanism. Further, the compact utility loader 100 may be implemented as a walk-behind or as a riding model.

A landscaping apparatus 104 is mounted to the universal attachment bracket 102 via a meeting plate 106, which may be secured to the universal attachment bracket 102, for example, by one or more pins. Because the meeting plate 106 is compatible with the universal attachment bracket 102, the landscaping apparatus 104 can be used with any of a variety of motorized implements that have a universal attachment bracket 102. An arm 108 extends from the meeting plate 106 and wraps around the front of the compact utility loader 100. The arm 108 further extends toward the back of the compact utility loader 100 along a side of the compact utility loader 100, terminating at a location between the front and back of the compact utility loader 100. In this way, even though the landscaping apparatus 104 is attached to the front of the compact utility loader 100, a landscaping tool may be attached to the arm 108 at a location near the side of and between the front and back of the compact utility loader 100.

A landscaping tool, such as an edging tool 110, is attached at the terminus of the arm 108. The edging tool 110 includes a cutting wheel 112, which digs a trench when the edging tool 110 is brought sufficiently close to the ground. A shroud 114 covers the cutting wheel 112 to prevent dirt and other matter from scattering excessively widely when the cutting wheel 112 is in operation. A guide wheel 116 maintains the shroud 114 above ground level to prevent the shroud 114 from dragging along the ground in operation.

In operation, the arm 108 remains in a raised position until the compact utility loader 100 is transported to the desired location for trench digging. When the compact utility loader 100 reaches the desired location, the arm 108 is lowered, causing the edging tool 110 to move toward the ground. Hydraulic lines 118 convey hydraulic fluid to a hydraulic motor, which drives the cutting wheel 112. The hydraulic motor (not shown) can be implemented, for example, as a Parker hydraulic motor. The cutting wheel 112 may be driven by a chain drive arrangement or, alternatively, by a direct drive arrangement, which may be advantageous in that such an arrangement involves fewer parts.

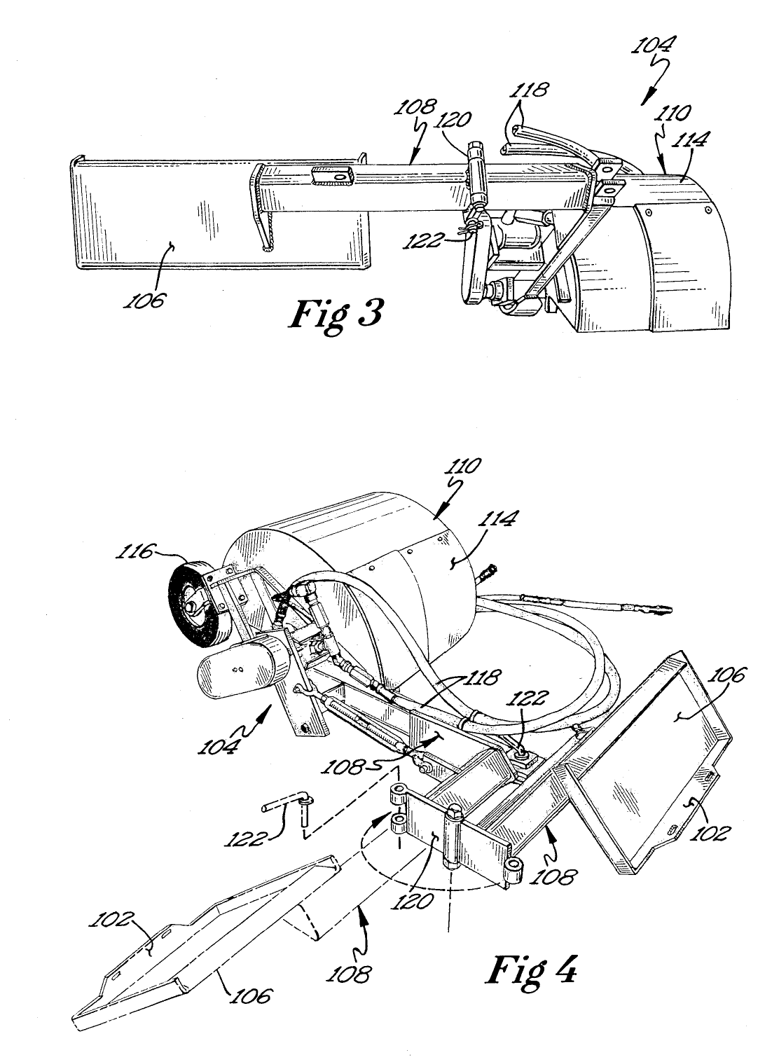

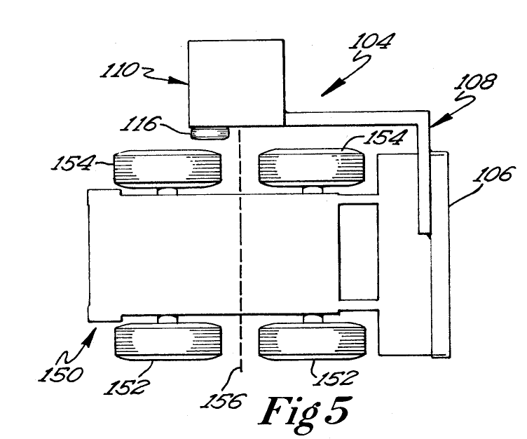

When the landscaper is finished digging the trench, the arm 108 is again raised. In some embodiments, the arm 108 is articulated so that the landscaping apparatus 104 can be folded compactly for storage, for example, on a standard size pickup truck. FIG. 3 illustrates the arm 108 in an operating configuration. The arm 108 has a hinge 120 that is locked in an open position by a storage pivot pin 122 when the landscaping apparatus 104 is in use. When the landscaping apparatus 104 is to be stored, the storage pivot pin 122 is removed, and the arm 108 is pivoted around the hinge 120 such that the hinge 120 is placed in a relatively closed position. With the arm 108 pivoted in this way, the storage pivot pin 122 is replaced, and the hinge 120 is thus locked in the closed position. The arm 108 is now folded in a compact configuration particularly suitable for storage. FIG. 4 depicts the arm 108 in the storage configuration.

The landscaping apparatus 104 can be positioned at any location alongside the motorized implement between the front and the rear extremes of the motorized implement. FIG. 5 illustrates a top view of a motorized implement, embodied as a skid-steer loader 150. One example of a skid-steer loader is a BOBCAT skid-steer loader, commercially available from Bobcat Company of West Fargo, N. Dak. In the embodiment of FIG. 5, the skid-steer loader 150 has a first set of wheels 152 on one side and a second set of wheels on an opposite side. Alternatively, the skid-steer loader 150 may have a pair of tracks (not shown), one track on either side of the skid-steer loader 150. In the embodiment of FIG. 5, the skid-steer loader 150 has a fixed frame with both wheels 152 on one side turning together independently of wheels 154 on the opposite side of the skid-steer loader 150. In embodiments in which tracks provide locomotion, the tracks on either side of the skid-steer loader run independently of each other. With the steering mechanism shown in FIG. 5, the skid-steer loader 150 can turn through 360 degrees within its own length, pivoting about a pivot point 156.

To take advantage of the maneuverability of the skid-steer loader 150, the landscaping apparatus 104 may be positioned near the pivot point 156. Positioning the landscaping apparatus 104 even with the pivot point 156, as shown in FIG. 5, may provide maximum maneuverability. However, in some cases, it may be desirable to position the landscaping apparatus 104 somewhat forward of the pivot point 156 to enhance the visibility of the landscaping apparatus from the perspective of the operator. In still other applications, it may be desirable to position the landscaping apparatus 104 somewhat rearward of the pivot point 156.

As demonstrated by the foregoing discussion, various embodiments may provide certain advantages, particularly in the context of landscaping applications. For instance, with the landscaping tool located proximate the pivot point of the motorized implement, the effective turn radius of the landscaping tool may be reduced, thereby enhancing maneuverability. As a result, a landscaping professional can dig trenches that have relatively complex patterns, including sharp turns and corners. Enhanced maneuverability can also be an advantage for landscaping tools other than edging tools, such as, for example, sod cutters and cable plows. The landscaping tool can be operated in conjunction with either a riding motorized implement, such as a skid-steer loader, or a walk-behind motorized implement, such as a compact utility loader.

It will be understood by those who practice the embodiments described herein and those skilled in the art that various modifications and improvements may be made without departing from the spirit and scope of the disclosed embodiments. The scope of protection afforded is to be determined solely by the claims and by the breadth of interpretation allowed by law.

What is claimed is:

1. A landscaping apparatus for use with a motorized implement, the landscaping apparatus comprising:
a landscaping tool; and
a mounting assembly for mounting the landscaping tool proximate a side portion of the motorized implement.

2. The landscaping apparatus of claim 1, wherein the motorized implement comprises an attachment bracket and the mounting assembly comprises:
a meeting plate configured to be attached to the attachment bracket; and
an arm extending from the meeting plate and along a front portion of the motorized implement, the arm further extending along a side portion of the motorized implement toward a back portion of the motorized implement, the arm having a terminus located between the front portion and the back portion of the motorized implement.

3. The landscaping apparatus of claim 2, wherein the landscaping tool is attached proximate the terminus of the arm.

4. The landscaping apparatus of claim 2, wherein the arm is operable in a raised position for transporting the landscaping tool and in a lowered position for bringing the landscaping tool into engagement with the ground.

5. The landscaping apparatus of claim 2, wherein the arm comprises:
a hinge for reconfiguring the arm between an operating position and a storage position; and
a pin configured and arranged to lock the hinge in an open position to configure the arm in the operating position and to lock the hinge in a relatively closed position to configure the arm in the storage position.

6. The landscaping apparatus of claim 1, wherein the landscaping tool comprises an edging tool.

7. The landscaping apparatus of claim 5, wherein the edging tool comprises:
a cutting wheel configured to, when the edging tool is brought proximate the ground, dig a trench in the ground;
a shroud covering the cutting wheel; and
a guide wheel.

8. The landscaping apparatus of claim 1, wherein the landscaping tool comprises a sod cutter.

9. The landscaping apparatus of claim 1, wherein the landscaping tool comprises a cable plow.

10. The landscaping apparatus of claim 1, wherein the motorized implement is a skid-steer loader.

11. The landscaping apparatus of claim 1, wherein the motorized implement is a compact utility loader.

12. The landscaping apparatus of claim 11, wherein the compact utility loader is operated in a walk-behind configuration.

13. The landscaping apparatus of claim 11, wherein the compact utility loader is operated in a riding configuration.

14. The landscaping apparatus of claim 1, wherein the motorized implement is characterized by a pivot point, and wherein the landscaping tool is located proximate the pivot point.

15. The landscaping apparatus of claim 1, wherein the motorized implement has a front portion and a rear portion and is characterized by a pivot point, and wherein the landscaping tool is located between the front portion and the pivot point.

16. The landscaping apparatus of claim 1, wherein the motorized implement has a front portion and a rear portion and is characterized by a pivot point, and wherein the landscaping tool is located between the rear portion and the pivot point.

17. An apparatus for use with a motorized implement having an attachment bracket configured to provide an attachment point for any of a variety of tools, the apparatus comprising:
a meeting plate configured to be attached to the attachment bracket;
an arm extending from the meeting plate and along a side portion of the motorized implement toward a back portion of the motorized implement, the arm having a terminus located proximate the side portion of the motorized implement; and
a tool attached to the terminus of the arm.

18. The apparatus of claim 17, wherein the arm comprises:
a hinge for reconfiguring the arm between an operating position and a storage position; and
a pin configured and arranged to lock the hinge in an open position to configure the arm in the operating position and to lock the hinge in a relatively closed position to configure the arm in the storage position.

19. The landscaping apparatus of claim 17, wherein the tool is selected from the group consisting of an edging tool, a sod cutter, and a cable plow.

20. The landscaping apparatus of claim 17, wherein the motorized implement is characterized by a pivot point, and wherein the tool is located proximate the pivot point.
